(19) United States
(12) Patent Application Publication
(10) Pub. No.: US 2005/0180000 A1
(43) Pub. Date: Aug. 18, 2005

(54) Stand adapter for a telescope and binocular telescope

(76) Inventors: Markus Becker, Solms (DE); Volker Claudi, Lahnau (DE); Klaus Felgenhauer, Wetzlar (DE)

Correspondence Address: HARNESS, DICKEY & PIERCE, P.L.C., P.O. BOX 828, BLOOMFIELD HILLS, MI, 48303, US

(21) Appl. No.: 11/052,196

(22) Filed: Feb. 7, 2005

(30) Foreign Application Priority Data
Feb. 13, 2004 (DE) 10 2004 008 454.8

(51) Int. Cl. G02B 23/00

(52) U.S. Cl. 359/430; 359/407

(57) ABSTRACT

A stand adapter for a telescope and a binocular telescope are disclosed. The stand adapter comprises a support surface for the telescope and a band for securing the telescope on the support surface. The support surface is at least partially configured arc-shaped, such that with a binocular telescope the barrels of the telescope rest on arcuate sections of the support surface.

### FIELD OF THE INVENTION

The present invention is related to the field of telescopes and, more particularly to the field of adapters for securing such telescopes on a stand, for example on a tripod.

More specifically, the invention is related to a stand adapter for a telescope, comprising a support surface for the telescope and a band for securing the telescope on the support surface.

Further, the invention is related to a binocular telescope having a stand adapter, the stand adapter being provided with a support surface for the telescope and a band for securing the telescope on the support surface.

### BACKGROUND OF THE INVENTION

A stand adapter and a binocular telescope of the afore-mentioned type are disclosed in document U.S. Pat. No. 5,221,991.

Stand adapters are used for securing a telescope on a stand, for example on a tripod. Conventional stand adapters for monocular and for binocular telescopes are so configured that they are attached to the underside of the telescope and have on their own underside a thread configured like a thread on the underside of a film or a photo camera. The telescope may thus be bolted on a head of a stand via the stand adapter. The stand head, in turn, is adapted to be swivelled in one or more planes. The telescope, when arranged on the stand, may, therefore be fixedly secured in a predetermined orientation.

These conventional stand adapters have the disadvantage that the telescope itself must be equipped with a standardized fastener for the stand adapter. Only such telescopes may be used in connection with such a stand adapter.

The stand adapter according to document U.S. Pat. No. 5,221,991 is provided with a plane metal plate. A thick layer of plastic foam material is arranged on the plate and may be provided with two elongate rounded troughs for receiving the barrels of a binocular telescope. A center portion of a band is affixed to the metal plate in a position between the troughs. The free ends of the band are configured as Velcro bands and may be guided through lateral slots in the metal plate. The free ends of the band thus form loops for securing the telescope barrels resting in the troughs.

This prior art stand adapter, therefore, has the disadvantage that it may only be used for telescopes having barrels extending relatively long and freely from the hinge. Moreover, it is complicated in its handling because the barrels have to be inserted through the loops and have to be secured individually thereafter.

Document U.S. Pat. No. 4,557,451 discloses another stand adapter for a binocular telescope. This adapter is likewise provided with a plate having a surface with two parallel elongate rounded troughs configured as a negative form as compared to the shape of the barrels of the telescope. For securing the telescope to the support, a band is provided, one end of which being attached to one side of the support and the other end of which being adapted to be attached to the opposite side of the support by means of a Velcro element. The band encircles the middle section of the tubes of the telescope which had been placed into the troughs before.

This prior art telescope has the disadvantage that due to its shape it may only be used in conjunction with telescopes having a corresponding counter-shape. It may, therefore, only be used as an accessory for a specific telescope. Although the telescope is secured to the stand adapter, it is not possible, or only to a very limited extent, to vary the distance between the pupils. If the troughs were dimensioned larger to allow a variation of the pupil distance, this would mean that the pupil distance could not be held in a stable manner because it would become misadjusted, in particular when the band is pulled tight. As this prior art stand adapter may only be used for a specific telescope, a manufacturer of various different telescopes must offer likewise different stand adapters for any distinctly shaped telescope, which is disadvantageous from a cost point of view.

It is, therefore, an object underlying the invention to improve a stand adapter and a binocular telescope of the type specified at the outset such that these disadvantages are avoided. In particular, the stand adapter shall be adapted to be used for a large variety of telescopes. Further, it shall become possible to secure the telescope on the stand adapter and to simultaneously vary the pupil distance as much as the design of the telescope allows. When doing so it shall be ensured that the set pupil distance is not misadjusted during the use of the stand adapter, in particular when the telescope is secured tight.

### SUMMARY OF THE INVENTION

In a stand adapter of the type specified at the outset, this object is achieved in that the support surface is at least partially configured arc-shaped.

In a binocular telescope of the type specified at the outset, the object is achieved in that the support surface is at least partially configured arc-shaped, such that barrels of the telescope rest on arcuate sections of the support surface.

The object underlying the invention is thus entirely solved. The arcuate shape of the support namely allows to place almost any common telescope onto the support surface and to secure same thereonto. There are no limitations with respect to specific types of telescopes. In contrast, small telescopes, medium-sized telescopes as well as large telescopes with Porro-prisms may likewise be utilized.

This holds true in particular for binocular telescopes with two barrels. The two barrels namely rest on the arcuate support one adjacent the other, independent from their size, design or distance therebetween.

In a preferred embodiment of the stand adapter according to the invention the support surface is arcuate over its entire length.

This measure has the advantage that the support surface may be manufactured simply and at low cost.

The support surface in that case is preferably convex arcuate over its entire length.

This has the advantage that the telescope is self-centered because the curvature and the tension within the band act in opposite directions. The set pupil distance is, therefore, self-stabilized.

In this connection it is further preferred when the support surface in a cross-section is circular arc shaped, in particular when the circular arc has a radius (R) in the range of between 30 and 150 mm, preferably between 40 and 80 mm, in particular about 60 mm.

These measures have the advantage that the support surface may be manufactured in a still simpler and more cost-effective way. In the course of experiments it has turned out that the afore-mentioned radii are optimal for a large band of common telescopes.

In another group of embodiments of the invention the support surface has a conical shape, the cone angle being half the angle between an optical axis of the telescope and support lines of a barrel of the telescope on the support surface. Under extreme conditions this would also include a situation where the cone angle is zero.

This measure has the advantage that the optical axis or the telescopes axes, resp., extends or extend, resp., in a horizontal direction when the stand adapter is set to likewise extend horizontally because a conical shape of the barrel or barrels, resp., is compensated for by the shape of the support surface.

In particular situations the support surface, may, of course, also be shaped otherwise, for example have the shape of an elliptical arc, as viewed in a cross-section.

It is particularly preferred when the support surface is provided with an anti-gliss coating, by. For example, configuring the coating as a rubber layer.

This measure contributes to prevent an undesired misadjustment of the pupil distance when the telescope is secured tight on the stand adapter. Further, when the anti-gliss coating is effective, the required tightening force is reduced.

It is further preferred when the band is elastic, in particular when means are provided for setting a pull force within the band.

This measure has the advantage thet the pulling force may be set sensitively and well-dosed.

In still other embodiments of the invention the support surface is configured on a support, and that the support is held by an elongate holding arm extending essentially perpendicular to the support surface. Preferably, the holding arm is bent.

This measure has the advantage that a mechanically stable configuration is generated, in which the necessary manipulation may be easily effected. The bending of the holding arm has the advantage that the telescope comes to lie slightly offset from the stand axis so that the user may easier look into same.

It has already been mentioned that the inventive stand adapter may be used for monocular as well as for binocular telescopes. However, it is particularly preferred when the telescope is binocular, the barrels of which resting on arcuate sections of the support surface.

Further advantages will become apparent from the description and the enclosed drawing.

It goes without saying that the afore-mentioned features as well as those that will be mentioned hereinafter may not only be used in the particular given combination but also in other combinations or alone without leaving the scope of the present invention.

### BRIEF DESCRIPTION OF THE DRAWINGS

Embodiments of the invention are shown in the drawing and will be explained in further detail in the subsequent description.

FIG. 1 is a front elevational view of an embodiment of an inventive stand adapter for a telescope;

FIG. 2 is an extremely schematic side elevational view of the stand adapter of FIG. 1, on a reduced scale; and

FIG. 3 is a perspective view of the stand adapter of FIG. 1, however, in conjunction with another telescope.

### DETAILED DESCRIPTION OF THE PREFERRED EMBODIMENTS

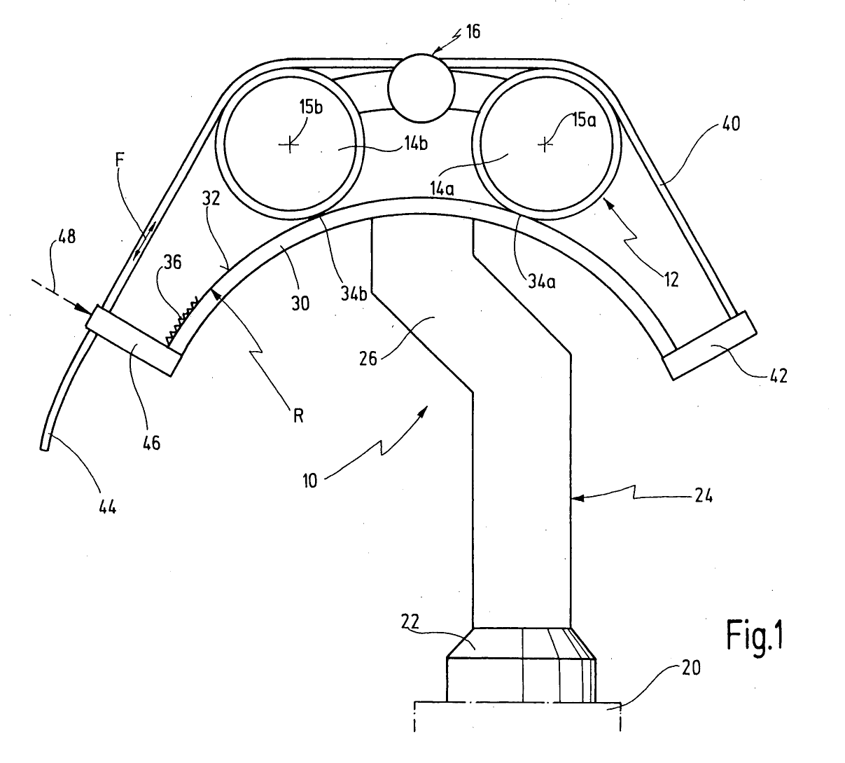

In FIG. 1 reference numeral 10 as a whole indicates a stand adapter. The stand adapter 10 serves to secure a telescope 12 on a stand of conventional design (not shown). In the embodiment of FIG. 1 the telescope 12 is a binocular telescope, which, however, must not necessarily be the case because the stand adapter 10 may also be used for monocular telescopes.

The telescope 12 is of conventional design. It has two barrels 14a and 14b being connected with each other via a hinge 16. The optical axes of barrels 14a and 14b are designated 15a and 15b,

In practical use, the stand adapter is placed onto a stand head 20, shown only schematically in FIG. 1, for example by means of an adapter element 22. The adapter element 22 is situated at the bottom of a holding arm 24. The holding arm 24 is elongate and extends essentially vertically. It is bent at 26. The upper end of holding arm 24 carries an arcuate and rigid support 30 extendig transversely to the holding arm 24 and having an upper support surface designated 32. The support surface 32 may be shaped arcuately over its full length or just along sections thereof.

The support surface 32, when viewed in a vertical cross-section, is shaped upwardly convex, as shown, however, for certain applications it may also be shaped concave. It is important that it is arcuate. The arcuate shape is preferably the shape of a circular arc. The radius of curvature of the circle may be in the range of between 30 and 150 mm, preferably in the range of between 40 and 80 mm, in particular about 60 mm. Other shapes of arc are also possible, for example that of an elliptic arc.

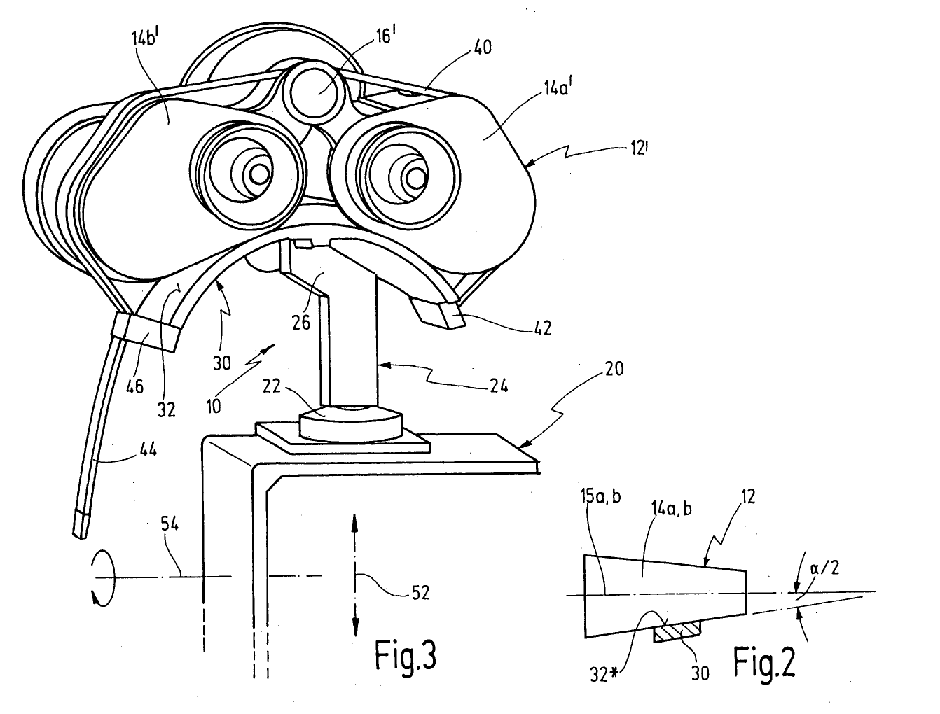

In an axial cross-section the support surface 32 may be plane, i.e. may extend horizontally in a normal position of use. However, as many telescopes have conically shaped barrels, an embodiment is preferred for those cases which is shown highly schematically in FIG. 2.

One can see the conical barrels 14a, 14b having a cone angle α. In that case the support surface 32* in an axial cross-section is inclined at an angle α/2 so that the telescope 12 in a normal position of use is oriented horizontally with its optical axes 15a, 15b. The support surface 32* then has a conical shape.

In any event, the barrels 14a, 14b, as shown in FIG. 1, rest on the support surface 32 via support points or support lines 34a, 34b, resp.,. When the support surface 32 is configured arcuately only in sections thereof, the support points 34a, 34b must lie within these arcuate sections. In order to prevent that barrels 14a, 14b glide and the pupil distance becomes misadjusted, the support surface 32 is preferably provided with an anti-gliss coating 36, for example with a rubber layer.

A band 40 is provided for securing the telescope 12 on the support surface 32. The band 40 is preferably elastic and e.g. configured as a rubber band. The right hand end of band 40, as seen in FIG. 1, is attached to a first terminal element 42 of the support 30. The opposite free end 44 of band 40 is guided through a second terminal element 46 at the opposite end of of support 30 and may be secured with positive or frictional engagement by means of a fastening assembly 48. By applying a predetermined and dosed tension to the band 40 prior to the securing, the pull force F within the band 40 may be set. The pull force F and the radius R act oppositely on the securing of the telescope on the support surface 32. By appropriately dosing the pulling force F the telescope may be stably secured in a predetermined position of the hinge 16, i.e. with a predetermined pupil distance.

The structural elements 22, 24, 30, 42 and 44 of the stand adapter are preferably made of a light metal or of a plastic material.

FIG. 3, in a perspective view, shows a situation in which a large telescope 12′ with Porro prisms is secured on the same stand adapter. One may easily see that this may be done without any problems and that the larger dimensions of telescope 12′ only result in another extension of the band 40.

FIG. 3 further indicates that stand head 20 is adapted to be adjusted in several axes, for example may be displaced along a vertical axis 52 or may be rotated about a horizontal axis 54.

1. A stand adapter for a telescope, comprising a support surface for said telescope and a band for securing said telescope on said support surface, wherein said support surface is at least partially configured arc-shaped.

2. The stand adapter of claim 1, wherein said support surface is arcuate over its entire length.

3. The stand adapter of claim 2, wherein said support surface is convex arcuate over its entire length.

4. The stand adapter of claim 3, wherein said support surface in a cross-section is circular arc shaped.

5. The stand adapter of claim 4, wherein said circular arc has a radius in the range of between 30 and 150 mm, preferably between 40 and 80 mm, in particular about 60 mm.

6. The stand adapter of claim 8, wherein said support surface has a conical shape, the cone angle being half the angle between an optical axis of the telescope and support lines of a barrel of the telescope on the support surface.

7. The stand adapter of claim 6, wherein said cone angle is zero.

8. The stand adapter of claim 3, wherein said support surface in a cross-section is elliptical.

9. The stand adapter of claim 1, wherein said support surface is provided with an anti-gliss coating.

10. The stand adapter of claim 9, wherein said coating is configured as a rubber support.

11. The stand adapter of claim 1, wherein said band is elastic.

12. The stand adapter of claim 11, wherein means are provided for setting a pull force in said band.

13. The stand adapter of claim 1 , wherein said support surface is configured on a support, said support being held by an elongate holding arm extending essentially perpendicular to said support surface.

14. The stand adapter of claim 13, wherein said holding arm is bent.

15. The stand adapter of claim 1, wherein said telescope is a binocular telescope, barrels of which resting on arcuate sections of said support surface.

16. A stand adapter for a binocular telescope, comprising a support surface for barrels of said telescope and a band for securing said telescope on said support surface, wherein said support surface is configured as one arc, such that said tubes rest on said arcuate support surface one adjacent the other.

17. A binocular telescope having a stand adapter, said stand adapter being provided with a support surface for said telescope, and a band for securing said telescope on said support surface, wherein said support surface is at least partially configured arc-shaped, such that barrels of said telescope rest on arcuate sections of said support surface.

18. A binocular telescope having a stand adapter, said stand adapter being provided with a support surface for said telescope, and a band for securing said telescope on said support surface, wherein said support surface is configured as one arc, such that barrels of said telescope rest on said support surface one adjacent the other.
